(19) United States
(12) Patent Application Publication
(10) Pub. No.: US 2013/0188559 A1
(43) Pub. Date: Jul. 25, 2013

(54) Method for Establishing a Communication Connection over the Internet Between Mobile Terminals, Computer Program, and Storage Medium

(71) Applicant: STREAMWIDE, Paris (FR)

(72) Inventor: Thomas Bouton, Paris (FR)

(73) Assignee: STREAMWIDE, Paris (FR)

(21) Appl. No.: 13/748,234

(22) Filed: Jan. 23, 2013

(30) Foreign Application Priority Data
Jan. 24, 2012 (FR) 12 50694

(51) Int. Cl. H04W 76/02

(52) U.S. Cl. CPC H04W 76/021
USPC 370/328

(57) ABSTRACT

A method for establishing a communication connection over the internet between a first mobile terminal and a second mobile terminal, the method comprising the transfer of connection data between mobile terminals using data text messages, and the establishing of a communication connection between the terminals over the internet using the transferred connection data.

### FIELD OF THE INVENTION

The invention relates to the field of mobile telephony, and more particularly to communication between mobile telephones over the internet.

### BACKGROUND OF THE INVENTION

For some time now, the latest generation of mobile telephones have had the ability to access the internet, for example to browse the web as has already been possible from a personal computer.

In addition to being able to browse the web, it is also possible to give mobile telephones access to other services available on the internet and already offered to personal computers, particularly services allowing mobile telephones to communicate with each other using the IP protocol.

For example, communication services such as voice-over-IP and instant messaging are very popular among users of personal computers, and it is desirable to allow mobile telephones to access such services in peer-to-peer mode.

Unfortunately, the technology for accessing the internet currently available to mobile phones is not really suitable for this type of service.

In fact, to establish IP communication connections between multiple cell phone users, generally a certain number of identifiers and addresses of intermediate servers that users do not usually know and cannot easily access must be configured.

Thus, when using the SIP protocol for internet telephony and instant messaging, it may be difficult for a mobile terminal to identify another mobile terminal wanting to establish a communication connection and determine in which network the other terminal is located.

Most importantly, and this is for example the case with smart phones or handheld devices, when an IP address is assigned randomly to a mobile terminal by the server of a service provider, this IP address is temporary and is only guaranteed for the duration of a specific connection, which further complicates the configuration of certain services provided over the internet, particularly when the mobile terminals are on the move and can change their access network.

### OBJECTS AND SUMMARY OF THE INVENTION

The invention aims to simplify establishing a communication connection between mobile telephones over the internet.

For this purpose, the invention proposes a method for establishing a communication connection over the internet between a first mobile terminal and a second mobile terminal, wherein connection data is transferred between said mobile terminals by means of data text messages, and a communication connection is established between said terminals by means of the transferred connection data, using a service provided on the internet.

By these arrangements, establishing a connection by an internet service simply requires knowing the telephone number or MSISDN (Mobile Station ISDN Number) of the person to be contacted.

The telephone number is both easy to obtain and to remember because it contains a reasonable number of digits and it is already commonly used in communications between users of a mobile network.

In addition, while the IP addresses may change with network connections and disconnections, the telephone number is a unique identifier that remains stable over time.

Lastly, the transfer of connection data by means of data text messages allows establishing the communication connection over the internet in a manner that is transparent to the terminal users.

In various embodiments of the method according to the invention, one or more of the following arrangements may possibly be used:
the step of transferring connection data comprises sending a first data text message from the first mobile terminal to the second mobile terminal, the first data text message comprising first identification data for the first terminal;
the first data text message additionally comprises identification data for the communication protocol used by the service provided on the Internet;
the step of transferring connection data comprises sending a second data text message from the second mobile terminal to the first mobile terminal, the second data text message comprising second identification data for the second terminal;
the step of transferring connection data comprises sending second identification data from the second mobile terminal to the first mobile terminal, by means of the internet;
the step of transferring connection data comprises, after the second terminal receives the first text message, the sending of an acknowledging message from the second mobile terminal to the first mobile terminal;
at least one step of sending identification data comprises an operation of automatically retrieving said identification data from the memory of the terminal;
at least one step of sending identification data comprises an operation, by a terminal, of automatically generating a data text message;
at least one step of sending identification data comprises an operation of automatically sending a data text message from one of the mobile terminals to the other, said message being sent over a mobile telephony network identifying the terminals by their telephone number;
at least one step of sending identification data comprises an operation, by a terminal, of automatically extracting first data text message data;
the identification data and the identification data of the service provided on the internet are assembled together within an http address and/or a uniform resource identifier;
the steps of transferring connection data and establishing a communication connection by means of a service provided on the internet are repeated in the event of a disconnection of the first mobile terminal or the second mobile terminal from the internet.

Another object of the invention is a computer program product comprising instructions suitable for implementing the method defined above, when this program is executed by a processor of a mobile terminal.

Another object of the invention is a non-transitory storage medium on which the computer program is stored.

### BRIEF DESCRIPTION OF THE DRAWINGS

The method that is an object of the invention will be better understood by reading the following description and examining the drawings, in which:

FIG. 1 is a general diagram illustrating a communication architecture that can employ a method for establishing a communication connection over the internet according to the invention;

FIG. 2 is a flow chart illustrating an embodiment of the method for establishing a communication connection over the internet according to the invention;

FIG. 3 is a flow chart illustrating an embodiment of the method for establishing a communication connection over the internet according to the invention.

### MORE DETAILED DESCRIPTION

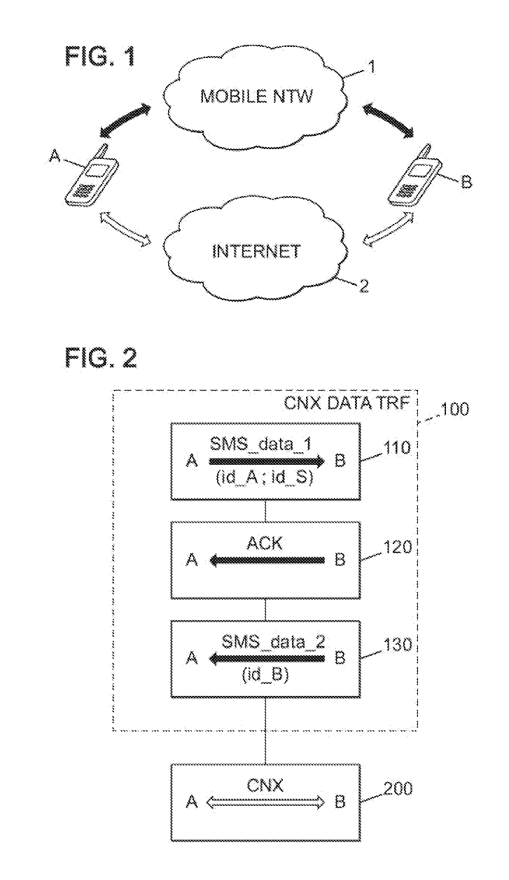

First, FIG. 1 will be described. In it are represented two mobile terminals A and B, connected to each other by a cellular network 1 (also called a public land mobile network), for example a GSM network (Global System for Mobile Communications), UMTS (Universal Mobile Telecommunications System), or later generation networks, and wanting to communicate with each other via the Internet 2.

In the following description, the term “mobile terminal” is understood to mean any device capable of using a cellular network or mobile telephony network, for example a cellular phone, a smart phone, or a portable computer or tablet equipped with a connection to a mobile network.

FIG. 2 will now also be described, which illustrates a specific embodiment of the method for establishing a communication connection over the internet according to the invention.

This method comprises a first step 100 of transferring connection data between said mobile terminals A and B. This step of transferring connection data occurs by sending data text messages, for example using the Short Message Service-Point to Point (SMS-PP) protocol as defined in the mobile telephony standard GSM 03.40.

The term “data text message” is understood here to mean an SMS text message which is not for display to the user, but usually serves to send data (invisibly to the user of the mobile terminal) needed by certain applications or services managed by the mobile terminal. This type of message is also referred to as an “SMS Data Message.”

Such data messages are defined in the standard GSM 03.40.

After this step 100 of transferring connection data using data text messages, the connection data transferred in this manner are then used, during a connection step 200, to establish a communication connection between the terminals A and B by means of a service provided on the internet. This connection can be established, for example, using the SIP protocol or any other TCP/IP protocol, for example HTTP or XMPP.

Thus, due to the use of such data text messages, the exchange of connection data necessary for establishing a communication connection over the internet between the terminals A and B can occur simply by means of the mobile telephony network, transparently to the users of terminals A and B. The connection is point to point, so it is not necessary to have a centralized infrastructure in addition to that of the existing cellular network in order to establish the connection.

In particular, the data transfer step comprises a first sub-step 110 of sending a first data text message SMS_data_1 from the first terminal A to the second terminal B; this message is sent over the cellular network.

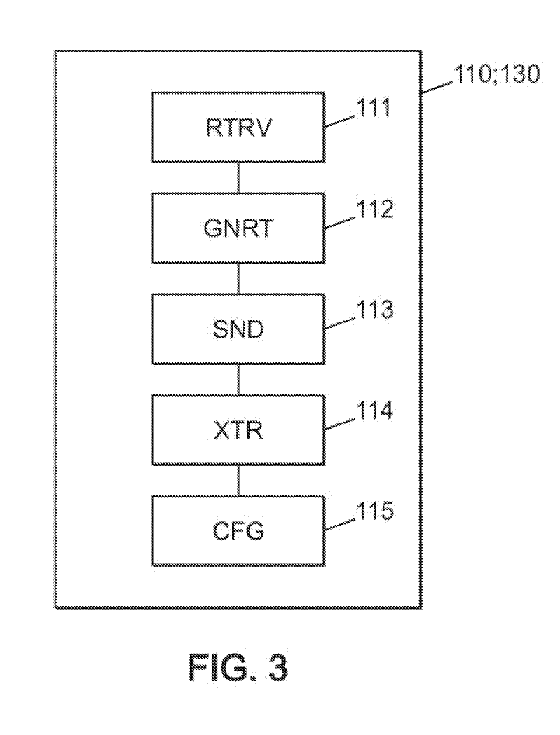

FIG. 3 will now also be described. It illustrates a particular embodiment, of a sub-step of sending a data text message, of a method according to the invention.

The first sub-step 110 may, for example, comprise a first operation 111 of automatically retrieving, from the memory of the first terminal A, identification data id_A for the first terminal A which will allow terminal B to establish a communication connection over the internet with terminal A.

This automatic retrieval operation may also comprise retrieving identification data id_S for the communication protocol used by the service provided over the internet, and to be used to enable the communication between the two terminals A and B. These identification data id_S may directly indicate the communication protocol or may indicate this protocol indirectly.

This operation can be performed by a transmission module installed in the first terminal A.

In yet another embodiment, the transmission module can be integrated into the operation system of the first terminal A.

Next, a second operation of generating the text message (operation 112) comprises the automatic generation of a first data text message SMS_data_1.

This first message SMS_data_1 may contain the identification data id_A for the first terminal A.

This first message SMS_data_1 may additionally contain the identification data id_S for the communication protocol.

The identification data for the first terminal A and for the communication protocol to be used for the communication may be introduced into separate specific fields of the data text message SMS_data_1 or may be assembled together within the same field, depending on the type of service enabling the communication between the two terminals.

During a third send operation 113, the first data text message SMS_data_1 is sent automatically over the mobile network from the first mobile terminal A to the second mobile terminal B. This transmission occurs by means of the mobile telephony network and therefore uses the telephone number or MSISDN number (Mobile Station ISDN Number) of the recipient as the recipient identifier.

The first data text message SMS_data_1 is received by the second terminal B, for example directly by a receiving module installed in the second terminal B, for example with the receiving module currently executing when the first message SMS_data_1 is received.

In an alternative embodiment, the first text message may be received by a module of the operating system of the second terminal B, for example a system of automated notifications or alerts which could for example notify the user or execute the program of the invention.

In yet another embodiment, the receiving module of the invention could be integrated into the operating system of the second terminal B.

A fourth operation 114 of automatically extracting first data text message data SMS_data_1 can then be performed by a module of the second terminal B, for example by the receiving module. This operation comprises the extraction of identification data id_A for the first terminal A and, if they exist, identification data id_S for the communication protocol.

A fifth configuration operation 115 comprises the updating, or as a variant the creation, based on the data extracted from the first data text message SMS_data_1, of a connection configuration for establishing the communication connection between the first terminal A and the second terminal B.

Thus, in certain embodiments, the second terminal B receiving identification data for the first terminal A on the one hand, and identification data for the communication protocol to be used to establish the connection between the two terminals on the other hand, is therefore able to establish the connection with the terminal A identified by the identification data id_A, by accessing the required service via the internet by means of the communication protocol identified by id_S. As a variant, the communication protocol to be used may not need to be provided, for example either because only one protocol is used, or because a prior choice of protocol was made.

As an example, in the case of a service based on the HTTP protocol, the second terminal B (then called the client terminal) is thus able to connect to the first terminal A (then called the server terminal).

When it is advantageous if the communication protocol used to communicate over the internet also knows from the first terminal A the identification data for the second terminal B, the step of transferring connection data additionally comprises a sub-step 130 of sending a second data text message SMS_data_2, from the second terminal B to the first terminal A. This second data text message SMS_data_2 then comprises identification data id_B for the second terminal B, which can be used by the first terminal A to communicate with this second terminal B.

This is the case, for example, when the communication protocol used to establish the communication connection over the internet is the SIP protocol. In this case, the first terminal A uses the address of the second terminal B to initiate the communication with that terminal, particularly for pricing purposes. Such a SIP protocol can then be used for the transmission of video calls, for example.

Another example is the case where the first terminal A proposes a voice-over-IP communication with the second terminal B. First of all, a first message SMS_data_1 is sent from the first to the second terminal as described above (sub-step 110). Then, software installed on the second terminal B can for example receive this first message and notify the user of the second terminal B. If said user indicates that he accepts the communication, a second message SMS_data_2 comprising the IP address of the second terminal B is sent back to the first terminal A which can then establish a communication connection using the desired protocol. The software installed on the second terminal B can accept this communication automatically.

In addition, if the first and second terminals A, B are both connected by private networks such as intranets (using network address translation NAT), the second terminal B can propose a proxy for the chosen protocol to the first terminal A so that the connection occurs without problems.

The sending of this second data text message SMS_data_2 comprises operations similar to those just described for sending the first data text message SMS_data_1, with the roles of the first and second terminals being exchanged.

Symmetrical sending and receiving modules will then be installed in the first and second terminals or will be an integral part of the operating systems of said terminals.

In a variant of this embodiment, the sending (sub-step 130) of identification data id_B for the second terminal B to the first terminal A can occur over the internet. This implementation may be advantageous in cases where the exchange of text messages is limited, for example due to the telecommunications service provider or to an excessively heavy load on the mobile network.

Advantageously, during the step of transferring connection data, a message ACK acknowledging receipt is sent by the second terminal B to the first terminal A during a sub-step 120, after receipt of the first data text message SMS_data_1 by the second terminal B, in order to confirm receipt of this first data text message SMS_data_1

A message ACK acknowledging receipt is defined in standard TS 23.402 and can be used for this purpose. However, this functionality of standard TS 23.402 is sometimes deactivated by telecommunications service providers, particularly during high traffic, and it may be advantageous to send a message ACK acknowledging receipt by another means, for example using a data text message according to the Short Message Service-Point to Point (SMS-PP) protocol as defined in the mobile telephony standard GSM 03.40.

Sending such a message ACK acknowledging receipt allows the first terminal A to know whether or not the second terminal B has indeed received the data text message SMS_data_1 and in particular whether the second data terminal B is in operation. However, the message ACK may not contain any information concerning the ability of the second terminal B to handle the communication protocol indicated by the first terminal A.

In effect, if the first terminal A does not receive the message ACK acknowledging receipt originating from the second terminal B, the first terminal A deduces from this that the absence of response from the second terminal B is due to the first data text message SMS_data_1 not being received. The first terminal A can then attempt to resend this message.

On the other hand, if the first terminal A receives the message ACK acknowledging receipt originating from the second terminal B but does not receive any second data text message SMS_data_2, the first terminal A deduces that the lack of response from the second terminal B is caused by the inability of terminal B to handle the type of communication protocol desired by the first terminal A (and indicated by the identification data id_S in the first data text message SMS_data_1).

In this case, the user of the first terminal A can then abandon trying to establish a communication connection with the second terminal B over the internet using that particular communication protocol.

In one embodiment of the invention, the first identification data id_A and the identification data id_S for the communication protocol are assembled together and presented in the form of an IP address, formulated for example using the http protocol, inserted into a field of the data text message SMS_data_1.

The IP address can thus be in the form:

sip://A@192.168.1.234

In this first embodiment, the second terminal B can then access the internet and use this IP address to communicate with the first terminal A.

Purely as an illustration, the two terminals A and B can then communicate by instant messaging, for example using the “jabber” instant messaging network or a SIP client.

Alternatively, the identification data id_A and the identification data for the requested service id_S can be assembled together in the form of a uniform resource identifier (or URI), inserted into a field of the data text message SMS_data_1.

A uniform resource identifier contains different identification elements, such as the IP address or the protocol for example. A uniform resource identifier additionally offers the advantage of being handled natively by some protocols.

Advantageously, the step 100 of transferring connection data between said mobile terminals A and B as well as the connection step 200 can be repeated when the first terminal A and/or the second terminal B are disconnected from the internet. In this manner, in case of a change of IP address following a disconnection and subsequent reconnection to the internet, the communication resumes between the terminals A and B using a service provided on the internet, transparently to the user.

Of course, the invention is not limited to the examples described and represented above, as other embodiments and implementations can be envisaged from these examples without leaving the scope of the invention.

Instant messaging services and video call forwarding have been described as possible applications of the invention. However, the invention can also apply to voice-over-IP exchanges, file exchanges, remote support, or synchronization of information such as calendars, contacts, or emails for example.

1. A method for establishing a communication connection over the internet between a first mobile terminal and a second mobile terminal, wherein connection data is transferred between said mobile terminals by means of data text messages, and a communication connection is established between said terminals by means of the transferred connection data, using a service provided on the internet.

2. The method according to claim 1, wherein the step of transferring connection data comprises sending a first data text message from the first mobile terminal to the second mobile terminal, the first data text message comprising first identification data for the first terminal.

3. The method according to claim 2, wherein the first data text message additionally comprises identification data for the communication protocol used by the service provided on the internet.

4. The method according to claim 2, wherein the step of transferring connection data comprises sending a second data text message from the second mobile terminal to the first mobile terminal, the second data text message comprising second identification data for the second terminal.

5. The method according to claim 2, wherein the step of transferring connection data comprises sending second identification data from the second mobile terminal to the first mobile terminal, by means of the internet.

6. The method according to claim 2, wherein the step of transferring connection data comprises, after the second terminal receives the first text message, the sending of an acknowledging message from the second mobile terminal to the first mobile terminal.

7. The method according to claim 2, wherein at least one step of sending identification data comprises an operation of automatically retrieving said identification data from the memory of the terminal.

8. The method according to claim 2, wherein at least one step of sending identification data comprises an operation, by a terminal, of automatically generating a data text message.

9. The method according to claim 2, wherein at least one step of sending identification data comprises an operation of automatically sending a data text message from one of the mobile terminals to the other, said message being sent over a mobile telephony network identifying the terminals by their telephone number.

10. The method according to claim 2, wherein at least one step of sending identification data comprises an operation, by a terminal, of automatically extracting first data text message data.

11. The method according to claim 2, wherein the identification data and the identification data of the service provided on the internet are assembled together within an http address and/or a uniform resource identifier.

12. The method according to claim 1, wherein the steps of transferring connection data and establishing a communication connection by means of a service provided on the internet are repeated in the event of a disconnection of the first mobile terminal or the second mobile terminal from the internet.

13. A computer program product comprising instructions suitable for implementing a method, when this program is executed by a processor of a mobile terminal, said method establishing a communication connection over the internet between a first mobile terminal and a second mobile terminal, wherein connection data is transferred between said mobile terminals by means of data text messages, and a communication connection is established between said terminals by means of the transferred connection data, using a service provided on the internet.

14. A non-transitory storage medium on which a computer program product is stored, said computer program product comprising instructions suitable for implementing a method, when this program is executed by a processor of a mobile terminal, said method establishing a communication connection over the internet between a first mobile terminal and a second mobile terminal, wherein connection data is transferred between said mobile terminals by means of data text messages, and a communication connection is established between said terminals by means of the transferred connection data, using a service provided on the internet.
